(19) United States
(12) Patent Application Publication
(10) Pub. No.: US 2023/0340708 A1
(43) Pub. Date: Oct. 26, 2023

(54) ABRASION RESISTANT WIPE AND MANUFACTURING METHOD THEREFOR

(71) Applicant: Xiamen Yanjan New Material Co., Ltd., Tong'an District (CN)

(72) Inventors: Qingzhong ZHENG, Tong'an District (CN); Shunxin HE, Tong'an District (CN); Danpin WU, Tong'an District (CN); Jihua XIE, Tong'an District (CN)

(21) Appl. No.: 18/217,638

(22) Filed: Jul. 3, 2023

Related U.S. Application Data
(62) Division of application No. 17/267,848, filed on Feb. 11, 2021.

(30) Foreign Application Priority Data
Jan. 15, 2019 (CN) 201910036152.X

(51) Int. Cl. D04H 1/4374; D04H 1/4382; A47K 10/02; D04H 1/4258; D04H 1/542; D04H 1/593; D04H 1/60

(52) U.S. Cl. CPC D04H 1/4374; D04H 1/43828; A47K 10/02; D04H 1/4258; D04H 1/542; D04H 1/593; D04H 1/60

(57) ABSTRACT

An abrasion resistant wipe and a manufacturing method therefor. The abrasion resistant wipe has an upper layer and a lower layer each being a meltblown fiber web and a middle layer being wood pulp fiber web; wherein the meltblown fiber web comprises meltblown fibers with fiber surface being high melting point resin and meltblown fibers with fiber surface comprising low melting point resin; there is a difference of ≥20° C. between melting point of the low melting point resin and melting point of the high melting point resin; percentage of the meltblown fibers with fiber surface comprising low melting point resin in total fibers of the meltblown fiber web is greater than 5%; the meltblown fibers of the meltblown fiber web penetrate in the wood pulp fiber web.

### CROSS REFERENCE TO RELATED APPLICATIONS

This application is a divisional application of Ser. No. 17/267,848 which is a PCT national phase application based on PCT/CN2019/087396 claiming the priority application 201910036152.X (CN109554824) in China.

### BACKGROUND OF THE INVENTION

The present invention relates to wipe technology and more particularly pertains to an abrasion resistant wipe with good surface abrasion resistance and anti-pilling properties for personal and infant care and a manufacturing method therefor.

Wipes are very convenient to carry, store and use, so they are very popular among vast consumers. Wipes are commonly used in daily life, such as when a parent replaces a diaper, or when dining in a restaurant, or during cosmetic skin care. It is obvious that wipes are more and more widely applied in personal and infant care.

Wipes may be made of spunlace nonwoven fabric or spunbond nonwoven fabric. In comparison with traditional wipes made of cloth, such wipes are convenient to manufacture, low in price, and can be used in dry and wet.

Chinese invention patent application number 93118457.6 discloses an abrasion resistant fiber nonwoven composite structure comprising the following two components: (1) a meltblown fiber substrate with a first outer surface, a second outer surface and an inner portion, and (2) at least one other fibrous material incorporated into the meltblown fiber substrate such that the concentration of the meltblown fibers near each outer surface of the nonwoven structure is at least about 60% by weight, and the concentration of the meltblown fibers at the inner portion is less than about 40% by weight. The wipe provides useful strength and low lint-shedding properties, as well as an abrasion resistance of at least 25% greater than the abrasion resistance of uniform mixtures of the same grade. By forming a more compact meltblown layer by the meltblown fibers on the surface, the wipe prevents to a certain extent the other fibrous material in the inner portion from falling out when in use. However, meltblown fibers are mostly formed by thermoplastic resins with higher melting points; when forming a consolidated meltblown layer, meltblown fibers are melted under high temperature after passing the thermal calendaring rollers, and thermal calendaring sites are formed under the action of a certain pressure, thereby consolidating the meltblown fibers together. As there is no adhesion among the meltblown fibers outside the thermal calendaring sites, the meltblown fibers without adhesion are prone to pilling after multiple frictions when in use, thus affecting the compactness of the surface layer and causing other fibrous material of the middle layer to fall out, therefore affecting usage life.

### BRIEF SUMMARY OF THE INVENTION

To overcome the shortcomings of existing products and manufacturing method, the present invention provides an abrasion resistant wipe with abrasion resistance and anti-pilling properties and a manufacturing method therefor.

To attain this, the present invention adopts the following technical solutions:
An abrasion resistant wipe has an upper layer and a lower layer each being a meltblown fiber web and a middle layer being a wood pulp fiber web;
wherein the meltblown fiber web comprises meltblown fibers with fiber surface being high melting point resin and meltblown fibers with fiber surface comprising low melting point resin; there is a difference of 20° C. between melting point of the low melting point resin and melting point of the high melting point resin; percentage of the meltblown fibers with fiber surface comprising low melting point resin in total fibers of the meltblown fiber web is greater than 5%; the meltblown fibers of the meltblown fiber web penetrates in the wood pulp fiber web.

The meltblown fibers with fiber surface comprising low melting point resin are single-component low melting point meltblown fibers, bicomponent meltblown fibers or a combination thereof.

The bicomponent meltblown fibers are bicomponent sheath-core type meltblown fibers, bicomponent orange peel type meltblown fibers or bicomponent side-by-side type meltblown fibers.

Percentage of the meltblown fibers with fiber surface comprising low melting point resin in total fibers of the meltblown fiber web is 30%-70%.

Weight of the wood pulp fiber web is more than 50% of total weight of the abrasion resistant wipe.

Weight of the wood pulp fiber web is 65%-80% of total weight of the abrasion resistant wipe.

The wood pulp fiber web comprises thermal melt adhesive.

A manufacturing method for the abrasion resistant wipe comprises the following steps:
(1) wood pulp is opened and loosened by an opening roller and then passes through a spray pipe under action of auxiliary air flow to form the wood pulp fiber web;
(2) by means of meltblown technology, two types of thermoplastic resins with melting points thereof differ from each other by 20° C. are heated respectively and thereafter input to a spinning box after melting; in the spinning box, melt trickles of the thermoplastic resins exit from spinnerets are blown into fiber bundles with fiber diameter smaller than or equal to 10 μm by high temperature and high speed hot air flow, thereby forming the meltblown fiber webs with the hot air flow; wherein the meltblown fiber webs each comprises meltblown fibers with fiber surface being high melting point resin and meltblown fibers with fiber surface comprising low melting point resin; percentage of the meltblown fibers with fiber surface comprising low melting point resin in total fibers of the meltblown fiber webs is greater than 5%; the meltblown fiber webs intersect at two sides of the wood pulp fiber web to form a multi-layer structural fiber web with the meltblown fiber webs at two sides and the wood pulp fiber web in middle;
(3) fiber webs of the multi-layer structural fiber web are consolidated together by a heating device to form the abrasion resistant wipe with the upper layer and the lower layer being the meltblown fiber webs comprising meltblown fibers with fiber surface being high melting point resin and meltblown fibers with fiber surface comprising low melting point resin and the middle layer being the wood pulp fiber web.

The spinnerets comprise bicomponent spinning nozzles.

The bicomponent spinning nozzles on the spinnerets are sheath-core type, orange peel type or side-by-side type.

The heating device is a hot air drying oven, thermal calendaring rollers or a combination thereof.

In step (1), the wood pulp is opened and loosened by the opening roller, and is then mixed with thermal melt adhesive, and thereafter passes through the spray pipe under action of auxiliary air flow to form a wood pulp fiber web comprising the thermal melt adhesive.

With the aforementioned technical solutions, the abrasion resistant wipe of the present invention can be manufactured by the abrasion resistant wipe manufacturing method of the present invention. The meltblown fiber webs of the abrasion resistant wipe of the present invention comprises meltblown fibers with fiber surface being high melting point resin and meltblown fibers with fiber surface comprising low melting point resin, and percentage of the meltblown fibers with fiber surface comprising low melting point resin in total fibers of the meltblown fiber webs is greater than 5%; during manufacture, the low melting point resin on fiber surface of the meltblown fiber with fiber surface comprising low melting point resin melts in the heating device, so that the fibers adhere together. In this way, the overall strength of the wipe is increased, and the abrasion resistance of the wipe is also increased, so that no pilling or linting occurs during wiping; at the same time, the fiber size of the meltblown fiber webs is small, the arrangement is compact, and the fibers are adhered together, thereby further preventing the middle layer wood pulp short fibers from falling out.

### BRIEF DESCRIPTION OF THE DRAWINGS

FIG. 1 is a schematic view of the manufacture of the abrasion resistant wipe of Embodiment 1 of the present invention.

FIG. 2 is a sectional view of the abrasion resistant wipe of Embodiment 1 of the present invention.

FIG. 3 is a schematic view of the manufacture of the abrasion resistant wipe of Embodiment 2 of the present invention.

FIG. 4 is a sectional view of the abrasion resistant wipe of Embodiment 2 of the present invention.

FIG. 5A is a sectional view of the sheath-core type meltblown fiber of the present invention.

FIG. 5C is a sectional view of the bicomponent side-by-side type meltblown fiber of the present invention.

FIG. 5C is a sectional view of the bicomponent orange peel type meltblown fiber of the present invention.

FIG. 6 is a schematic view of the manufacture of the abrasion resistant wipe of Embodiment 3 of the present invention.

FIG. 7 is a sectional view of the abrasion resistant wipe of Embodiment 3 of the present invention.

### DESCRIPTION OF THE REFERENCE LABELS

### Embodiment 1

Wood pulp 11 Wood pulp fiber web 12
Meltblown fiber webs 13, 14
Multi-layer structural fiber web 15 Abrasion resistant wipe 16
Opening roller A1 Spray pipe B1
Spinnerets C1, C1′

### Embodiment 2

Wood pulp 21 Wood pulp fiber web 22
Meltblown fiber webs 23, 24
Multi-layer structural fiber web 25 Abrasion resistant wipe 26
Opening roller A2 Spray pipe B2
Spinnerets C2, C2′ Thermal calendaring rollers E2
Bicomponent sheath-core type meltblown fiber 27
Bicomponent side-by-side type meltblown fiber 28
Bicomponent orange peel type meltblown fiber 29
Core layer resin 27a Sheath layer resin 27b
One type of the resin 28b, 29b
Another type of the resin 28a, 29a

### Embodiment 3

Wood pulp 31 Thermal melt adhesive 32
Wood pulp fiber web 33
Meltblown fiber webs 34, 35
Multi-layer structural fiber web 36 Abrasion resistant wipe 37
Opening roller A3 Spray pipe B3
Spinnerets C3, C3′ Hot air drying oven D3
Thermal calendaring rollers E3

### DETAILED DESCRIPTION OF THE INVENTION

In order to further explain the technical solutions of the present invention, the present invention is described in details with reference to specific embodiments.

### Embodiment 1

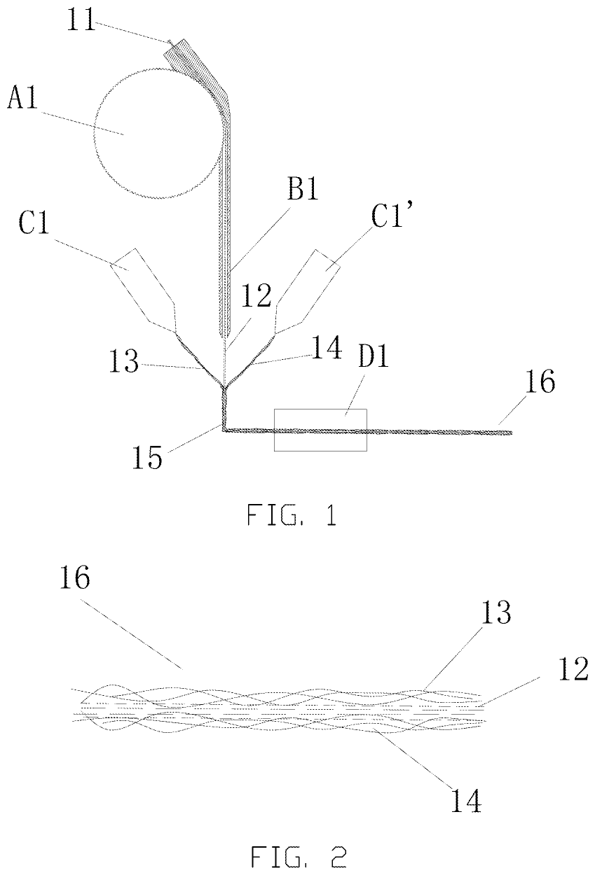

As shown in FIG. 1, the present invention discloses a manufacturing method for an abrasion resistant wipe comprising the following steps:
(1) Wood pulp 11 is opened and loosened by an opening roller A1 and then passes through a spray pipe B1 under action of auxiliary air flow to form a wood pulp fibrous web 12.
(2) By means of meltblown technology, high melting point thermoplastic resin (e.g. polypropylene PP) and low melting point thermoplastic resin (e.g. high density polyethylene HDPE) are heated respectively and thereafter input to a spinning box after melting; in the spinning box, melt trickles of the thermoplastic resins exit from spinnerets C1, C1′ are blown into fiber bundles with fiber diameter smaller than or equal to 10 μm by high temperature and high speed hot air flow, thereby forming meltblown fiber webs 13, 14 with the hot air flow; wherein the meltblown fiber webs 13, 14 each comprises meltblown fibers formed by high melting point thermoplastic resin PP with fiber surface being high melting point resin and single-component meltblown fibers formed by low melting point thermoplastic resin HDPE with fiber surface comprising low melting point resin, that is single-component low melting point meltblown fibers; percentage of the single-component meltblown fibers with fiber surface comprising low melting point resin in total fibers of the meltblown fiber webs 13, 14 is 40%; there is a difference of 20° C. between melting point of the high melting point resin and melting point of the low melting point resin; the meltblown fiber webs 13, 14 intersect at two sides of the wood pulp fiber web 12 to form a multi-layer structural fiber web 15 with the meltblown fiber webs 13, 14 at two sides and the wood pulp fiber web 12 in middle.
(3) Fiber webs of the multi-layer structural fiber web 15 are consolidated together by a hot air drying oven D1 to form a wipe 16 with an upper layer and a lower layer being the meltblown fiber webs 13, 14 and a middle layer being the wood pulp fiber web 12.

As shown in FIG. 2, the present invention also discloses an abrasion resistant wipe manufactured by the aforementioned abrasion resistant wipe manufacturing method. It has a layered structure. The abrasion resistant wipe 16 has an upper layer and a lower layer being the meltblown fiber webs 13, 14 and a middle layer being the wood pulp fiber web 12. The meltblown fiber webs 13, 14 each comprises meltblown fibers formed by high melting point thermoplastic resin PP with fiber surface being high melting point resin and single-component meltblown fibers formed by low melting point thermoplastic resin HDPE with fiber surface comprising low melting point resin; there is a difference of 20° C. between melting point of the high melting point resin and melting point of the low melting point resin; percentage of the single-component meltblown fibers with fiber surface comprising low melting point resin in total fibers of the meltblown fiber webs 13, 14 is 40%; the meltblown fibers of the meltblown fiber webs 13, 14 penetrate in the wood pulp fiber web 12.

Abrasion Resistance Test

With reference to standard GB/T13775-92 “Testing method for determination of the resistance to abrasion of cotton, ramie and silk spinning fabrics”

Testing equipment: YG(B)401E Martindale abrasion tester

Testing Materials:

Standard backing: a standard felt with a weight in m² of 750±50 g/m², a thickness of 3±0.5 mm and a diameter of 140 mm.

Sample backing material: polyurethane foam with a thickness of 3±0.5 mm, a density of 0.04 g/cm³ and a diameter of 38±2 mm.

Sample cutter: circular sample cutter with a sample diameter of 140 mm for obtaining a lower layer abradant with a sample size of φ140 mm,

Sample cutter: circular sample cutter with a sample diameter of 38 mm for obtaining an upper layer abradant with a sample size of φ38 mm.

Sample preprocessing: Testing samples are placed under room temperature for 24 hours.

Testing Steps:
1) Inspect components of the testing equipment to ensure normal operation of the testing equipment.
2) Obtain the lower layer abradant of φ140 mm by the sample cutter with a diameter of 144 mm and position the same on the standard backing, then position a sample loading hammer on the lower layer abradant and tighten the annular clamp to fix the abradant on a sample holder.
3) Obtain a sample of the upper layer abradant of φ38 mm by the sample cutter with a diameter of 38 mm, and by means of the sample cutter insert the sample into an A-type 200 g abrasion head metal clamp; a polyurethane foam with a diameter of 38 mm is positioned between the metal clamp and the abrasion head.
4) Position a sample clamp on an abrasion table so that a spindle passes through a bearing and insert on the sample clamp, then add a 395 g weight (395 g weight+200 g metal clamp weight produces a load of 583.1CN).
5) Switch on the equipment, set the rotation speed as 50 rotations per minute and number of rotations as 60; after setting, press “Start” button to start operation of the equipment; after completion of number of tests set by the equipment, the equipment stops; visually assess degree of pilling of the lower layer abradant.
6) Abrasion resistance assessment: determine abrasion resistance level with reference to abrasion resistance photographic standards.

TABLE 1

| | | | The abrasion |
|---|---|---|---|
| | Wipe | Wipe | resistant wipe of |
| | sold in the | sold in the | the present |
| Test item | market 1 | market 2 | invention |
| Abrasion resistance | 3 | 4 | 2 |
| level | | | |

As shown in the above table, in the abrasion resistant wipe 16 of the present invention, the meltblown fiber webs 13, 14 each comprises single-component meltblown fibers with fiber surface comprising low melting point resin; percentage of the single-component meltblown fibers with fiber surface comprising low melting point resin in total fibers of the meltdown fiber webs 13, 14 is 40%; during spinning, with arrangement of spinning nozzles, meltblown fibers with fiber surface being high melting point resin and single-component meltblown fibers with fiber surface comprising low melting point resin are mixed together, and when the meltblown fiber webs 13, 14 and the wood pulp fiber web 12 pass through the hot air drying oven D1, under action of hot air, surface of the single-component meltblown fibers with fiber surface comprising low melting point resin in the meltblown fiber webs 13, 14 starts to melt; as a result, the meltblown fibers adhere together, and the multi-layer structural fiber web 15 is adhered together to form the abrasion resistant wipe 16. In this way, the overall strength of the wipe is increased, and the abrasion resistance of the wipe is also increased, so that no pilling or linting occurs during wiping; at the same time, the fiber size of the meltblown fiber webs 13, 14 is small, the arrangement is compact, and the fibers are adhered together, thereby further preventing the middle layer wood pulp short fibers from falling out.

### Embodiment 2

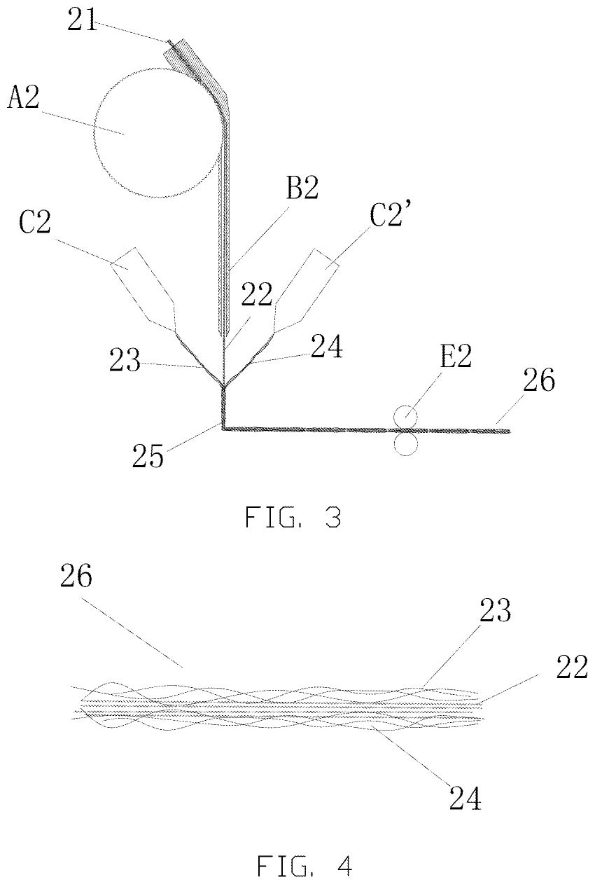

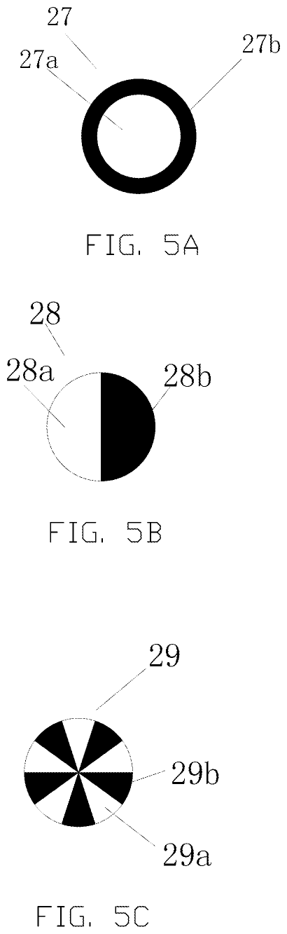

As shown in FIG. 3, the present invention discloses a manufacturing method for an abrasion resistant wipe comprising the following steps:
(1) Wood pulp 21 is opened and loosened by an opening roller A2 and then passes through a spray pipe B2 under action of auxiliary air flow to form a wood pulp fiber web 22.
(2) By means of meltblown technology, high melting point thermoplastic resin and low melting point thermoplastic resin are heated respectively and thereafter input to a spinning box after melting; in the spinning box, melt trickles of the thermoplastic resins exit from spinnerets C2, C2′ are blown into fiber bundles with fiber diameter smaller than or equal to 10 μm by high temperature and high speed hot air flow, thereby forming meltblown fiber webs 23, 24 with the hot air flow; wherein spinning nozzles on the spinnerets C2, C2′ comprises bicomponent spinning nozzles; the bicomponent spinning nozzles on the spinnerets C2, C2′ are sheath-core type, orange peel type or side-by-side type; the meltblown fiber webs 23, 24 passing through the bicomponent spinning nozzles comprise meltblown fibers with fiber surface being high melting point resin and bicomponent meltblown fibers with fiber surface comprising low melting point resin; as shown in FIGS. 5A to 5C, the bicomponent meltblown fibers are bicomponent sheath-core type meltblown fibers 27, bicomponent orange peel type meltblown fibers 29 or bicomponent side-by-side type meltblown fibers 28, and there is a difference of 20° C. between melting point of sheath layer resin 27b and melting point of core layer resin 27a of the bicomponent sheath-core type meltblown fibers 27; there is a difference of 20° C. between melting point of one type of the resin 28b, 29b and melting point of another type of the resin 28a, 29a of the bicomponent side-by-side type meltblown fibers 28 and the bicomponent orange peel type meltblown fibers 29; percentage of the bicomponent meltblown fibers in total fibers of the meltblown fiber webs 23, 24 is 50%; the meltblown fiber webs 23, 24 intersect at two sides of the wood pulp fiber web 22 to form a multi-layer structural fiber web 25 with the meltblown fiber webs 23, 24 comprising the bicomponent meltblown fibers at two sides and the wood pulp fiber web 22 in middle.
(3) Fiber webs of the multi-layer structural fiber web 25 are consolidated together by a pair of engaging thermal calendaring rollers E2 to form an abrasion resistant wipe 26 with an upper layer and a lower layer being the meltblown fiber webs 23, 24 comprising the bicomponent meltblown fibers and a middle layer being the wood pulp fiber web 22.

As shown in FIG. 4, the present invention also discloses an abrasion resistant wipe manufactured by the aforementioned abrasion resistant wipe manufacturing method. It has a layered structure. The abrasion resistant wipe 26 has an upper layer and a lower layer being the meltblown fiber webs 23, 24 and a middle layer being the wood pulp fiber web 22. The meltblown fiber webs 23, 24 each comprises meltblown fibers with fiber surface being high melting point resin and bicomponent meltblown fibers with fiber surface comprising low melting point resin; there is a difference of 20° C. between melting point of the high melting point resin and melting point of the low melting point resin; the bicomponent meltblown fibers with fiber surface comprising low melting point resin are bicomponent sheath-core type meltblown fibers 27, bicomponent orange peel type meltblown fibers 29 or bicomponent side-by-side type meltblown fibers 28; percentage of the bicomponent meltblown fibers in total fibers of the meltblown fiber webs 23, 24 is 50%; the meltblown fibers of the meltblown fiber webs 23, 24 penetrate in the wood pulp fiber web 22.

In this embodiment, during spinning, with arrangement of the bicomponent spinning nozzles, meltblown fibers with fiber surface being high melting point resin and bicomponent meltblown fibers with fiber surface comprising low melting point resin are mixed together when forming the meltblown fibers, and when the wood pulp fiber web 22 and the meltblown fiber webs 23, 24 pass through the thermal calendaring rollers, thermal calendaring sites for melting can be formed under action of thermal calendaring pressure at thermal calendaring regions, while in non-thermal calendaring regions, due to action of temperature, low melting point resin at surface of the bicomponent meltblown fibers of the meltblown fiber webs 23, 24 starts to melt; as a result, the meltblown fibers adhere together, and the multi-layer structural fiber web 25 is consolidated together to form the abrasion resistant wipe 26. In this way, the abrasion resistance of the wipe is increased, so that no pilling or linting occurs during wiping; at the same time, the overall strength of the wipe is increased, facilitating multiple wiping.

### Embodiment 3

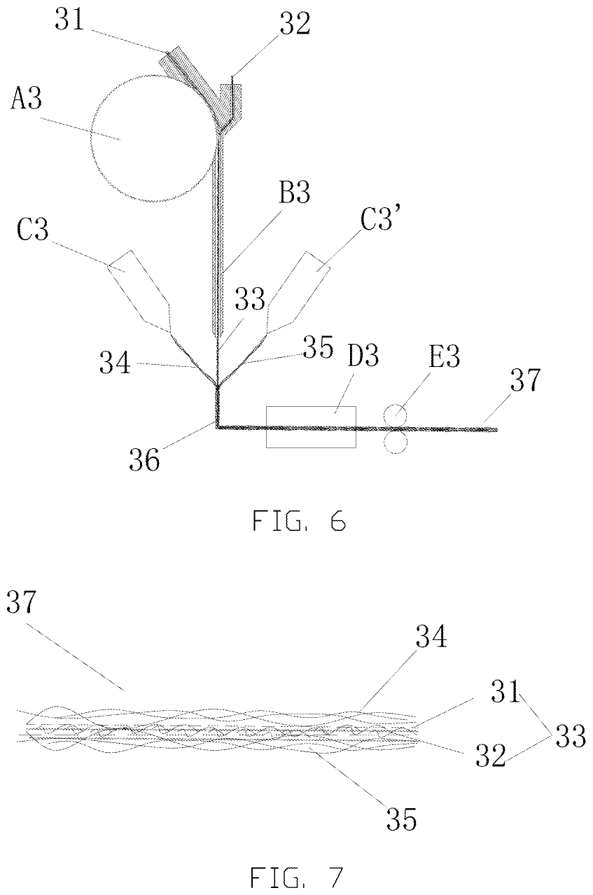

As shown in FIG. 6, the present invention discloses a manufacturing method for an abrasion resistant wipe comprising the following steps:
(1) Wood pulp 31 is opened and loosened by an opening roller A3, and is then mixed with thermal melt adhesive 32, and thereafter passes through a spray pipe B3 under action of auxiliary air flow to form a wood pulp fiber web 33 comprising the thermal melt adhesive.
(2) By means of meltblown technology, high melting point thermoplastic resin and low melting point thermoplastic resin are heated respectively and thereafter input to a spinning box after melting; in the spinning box, melt trickles of the thermoplastic resins exit from spinnerets C3, C3′ are blown into fiber bundles with fiber diameter smaller than or equal to 10 μm by high temperature and high speed hot air flow, thereby forming meltblown fiber webs 34, 35 with the hot air flow; wherein the meltblown fiber webs 34, 35 each comprises meltblown fibers with fiber surface being high melting point resin and meltblown fibers with fiber surface comprising low melting point resin; the meltblown fibers with fiber surface comprising low melting point resin are single-component low melting point meltblown fibers and bicomponent meltblown fibers; percentage of the meltblown fibers with fiber surface comprising low melting point resin in total fibers of the meltblown fiber webs 34, 35 is 20%; there is a difference of 20° C. between melting point of the low melting point resin and melting point of the high melting point resin; the meltblown fiber webs 34, 35 intersect at two sides of the wood pulp fiber web 33 comprising the thermal melt adhesive to form a multi-layer structural fiber web 36 with the meltblown fiber webs 34, 35 at two sides and the wood pulp fiber web 33 comprising the thermal melt adhesive in middle.
(3) Fiber webs of the multi-layer structural fiber web 36 are consolidated together by a hot air drying oven D3 and a pair of engaging thermal calendaring rollers E3 to form an abrasion resistant wipe 37 with an upper layer and a lower layer being the meltblown fiber webs 34, 35 comprising the single-component low melting point meltblown fibers and bicomponent meltblown fibers and a middle layer being the wood pulp fiber web 33 comprising the thermal melt adhesive 32.

As shown in FIG. 7, the present invention also discloses an abrasion resistant wipe manufactured by the aforementioned abrasion resistant wipe manufacturing method. It has a layered structure. The abrasion resistant wipe 37 has an upper layer and a lower layer being the meltblown fiber webs 35, 36 and a middle layer being the wood pulp fiber web 33 comprising the thermal melt adhesive 32. The meltblown fiber webs 34, 35 each comprises meltblown fibers with fiber surface being high melting point resin and single-component meltblown fibers with fiber surface comprising low melting point resin; there is a difference of 20° C. between melting point of the high melting point resin and melting point of the low melting point resin; the single-component meltblown fibers are single-component low melting point meltblown fibers and bicomponent meltblown fibers; percentage of the single-component low melting point meltblown fibers in total fibers of the meltblown fiber webs 34, 35 is 20%; the meltblown fibers of the meltblown fiber webs 34, 35 penetrate in the wood pulp fiber web 33.

In this embodiment, the wood pulp fiber web 33 of the middle layer is added with the thermal melt adhesive 32; in the hot air drying oven D3, the thermal melt adhesive 32 surface starts to melt, thereby fixing the wood pulp short fibers in the middle layer to a certain extent; as a result, the wood pulp short fibers are difficult to move, thus preventing linting during use of the wipe, reducing pilling of the wipe and increasing abrasion resistance.

What is claimed is:

1. A manufacturing method for the abrasion resistant wipe; said abrasion resistant wipe has an upper layer and a lower layer each being a meltblown fiber web and a middle layer being a wood pulp fiber web; wherein the meltblown fiber web comprises meltblown fibers with fiber surface being high melting point resin and meltblown fibers with fiber surface comprising low melting point resin; there is a difference of ≥20° C. between melting point of the low melting point resin and melting point of the high melting point resin;
percentage of the meltblown fibers with fiber surface comprising low melting point resin in total fibers of the meltblown fiber web is greater than 5%; the meltblown fibers of the meltblown fiber web penetrates in the wood pulp fiber web;
wherein the method comprises the following steps: (1) wood pulp is opened and loosened by an opening roller and then passes through a spray pipe under action of auxiliary air flow to form the wood pulp fiber web; (2) by means of meltblown technology, two types of thermoplastic resins with melting points thereof differ from each other by 20° C. are heated respectively and thereafter input to a spinning box after melting; in the spinning box, melt trickles of the thermoplastic resins exit from spinnerets are blown into fiber bundles with fiber diameter smaller than or equal to 10 μm by high temperature and high speed hot air flow, thereby forming the meltblown fiber webs with the hot air flow; wherein the meltblown fiber webs each comprises meltblown fibers with fiber surface being high melting point resin and meltblown fibers with fiber surface comprising low melting point resin;
percentage of the meltblown fibers with fiber surface comprising low melting point resin in total fibers of the meltblown fiber webs is greater than 5%; the meltblown fiber webs intersect at two sides of the wood pulp fiber web to form a multi-layer structural fiber web with the meltblown fiber webs at two sides and the wood pulp fiber web in middle; (3) fiber webs of the multi-layer structural fiber web are consolidated together by a heating device to form the abrasion resistant wipe with the upper layer and the lower layer being the meltblown fiber webs comprising meltblown fibers with fiber surface being high melting point resin and meltblown fibers with fiber surface comprising low melting point resin and the middle layer being the wood pulp fiber web.

2. The manufacturing method for the abrasion resistant wipe as in claim 1, characterized in that: the spinnerets comprise bicomponent spinning nozzles.

3. The manufacturing method for the abrasion resistant wipe as in claim 2, characterized in that: the bicomponent spinning nozzles on the spinnerets are sheath-core type, orange peel type or side-by-side type.

4. The manufacturing method for the abrasion resistant wipe as in claim 1, characterized in that: the heating device is a hot air drying oven, thermal calendaring rollers or a combination thereof.

5. The manufacturing method for the abrasion resistant wipe as in claim 1, characterized in that: in step (1), the wood pulp is opened and loosened by the opening roller, and is then mixed with thermal melt adhesive, and thereafter passes through the spray pipe under action of auxiliary air flow to form a wood pulp fiber web comprising the thermal melt adhesive.
